(19) United States
(12) Patent Application Publication
(10) Pub. No.: US 2007/0129989 A1
(43) Pub. Date: Jun. 7, 2007

(54) Optimized tire category management method

(76) Inventors: Brett Thomas Ponton, Canton, OH (US); Vinod Pius Raju, Uniontown, OH (US); Garey Patrick Smiley, Cuyahoga Falls, OH (US); Alvaro Enrique Mendoza, Copley, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/293,396

(22) Filed: Dec. 2, 2005

(51) Int. Cl. G06F 17/30

(52) U.S. Cl. 705/10

(57) ABSTRACT

A method of product category management that is not dependent on product sales history includes defining market segments to serve; setting a product screen of product characteristics for existing product lines and proposed product lines; calculating at least one trade area; determining product population and product demand potential within the trade area; deriving a store stocking solution based on product demand potential; and implementing the store stocking solution.

### FIELD OF THE INVENTION

The invention relates generally to a method for managing a product category and, more specifically, to an optimized category management method based operationally independent of category sales data.

### BACKGROUND OF THE INVENTION

Category management is a marketing term that involves a process that produces a plan, utilizing the variables of the marketing mix such as product, price, place, and promotion. The object of the plan is to optimize sales and profitability for a product category by focusing on consumer needs and the competitive environment.

More specifically, it is beneficial to understand the consumer and their needs at a local level in order to customize the assortment of products intended to address those needs. The goal is to increase category performance and not only a particular brand in the category by stocking the right products for each store (stocking solution).

The benefits an organized category management plan offers to the distributor is improved inventory management, improved sales, cash flow and profit optimization. A category management plan may also allow for more efficient product line introductions. For the manufacturer, a category management tool increases sales and profits, improves forecasting, and improves manufacturing efficiencies.

Traditionally, an integral part of a category management system began by defining marketing segments to serve and proposing metrics. Data is then collected relating sales history by store, stock keeping units (SKU's), units, revenue, and defining metrics. A line review is next conducted comparing existing and proposed product line profitability, rotation and product lines are added, maintained, or reduced based on their performance metrics. Store profiling is also conducted to calculate trade areas, and relevant product populations and potentials. A store stocking recommendation is then configured for each store using metrics, capacity, frequency of restocking and delivery, potential market, and sales history. The recommendations are reviewed and modified as needed. Product SKU's that are discontinued and stocking recommendations at each store are made by adjusting stocking levels and bringing new SKU's.

While working well, the above traditional approach may not be utilized when sensitive data relating to sales history by store, SKU's, units, and revenue is not available, or is available but not shared by the retailer with the manufacturer because of the sensitivity of such information. Without sales and volume historic data, making accurate store stocking recommendations and forecasts using traditional category management models becomes problematic.

Accordingly, there remains a need for a refined category management approach, system, and method that avoids the need for a sharing of sensitive sales, SKU, unit, and revenue information between the retailer at the end user level and the manufacturer/product supplier. Such a system should provide an acceptable level of accuracy in achieving management objectives such as stocking levels and forecasts. A suitable methodology further will be capable of adjustment over time as needed. Finally, a method that satisfies the industry's needs should be capable of convenient and cost effective implementation and execution.

### SUMMARY OF THE INVENTION

Pursuant to one aspect of the invention, a method of product category management comprises: defining market segments to serve; setting a product screen of product characteristics for existing product lines and proposed product lines; calculating at least one trade area; determining product population and product demand potential within the trade area; deriving a store stocking solution based on product demand potential; and implementing the store stocking solution. Results may be monitored to determine the necessity for an adjustment to the product screen.

According to another aspect of the invention, a method of tire category management comprises: conducting a tire category review; setting a tire screen positioning existing and proposed tire lines; creating a tire line table based on a plurality of tire information categories; profiling at least one store within at least one trade area; determining tire population and tire potential within the one trade area based tire characteristic; and deriving a store stocking recommendation based on the tire population and tire potential.

The tire population may be derived from a vehicle population within the trade area and the tire demand potential may be based at least partially on the age of the vehicle population within the trade area. The tire population may be age weighted within the trade area based upon vehicle population age.

### BRIEF DESCRIPTION OF THE DRAWINGS

The invention will be described by way of example and with reference to the accompanying drawings in which:

FIG. 1 is a block diagram of a prior art category management system;

FIG. 2 is a block diagram of the subject product category management system.

FIG. 3 is a chart showing the process for deriving an adjusted aged value of a product population; and

FIG. 4 is a schematic representation of a web based system implementing the subject method.

### DETAILED DESCRIPTION OF THE INVENTION

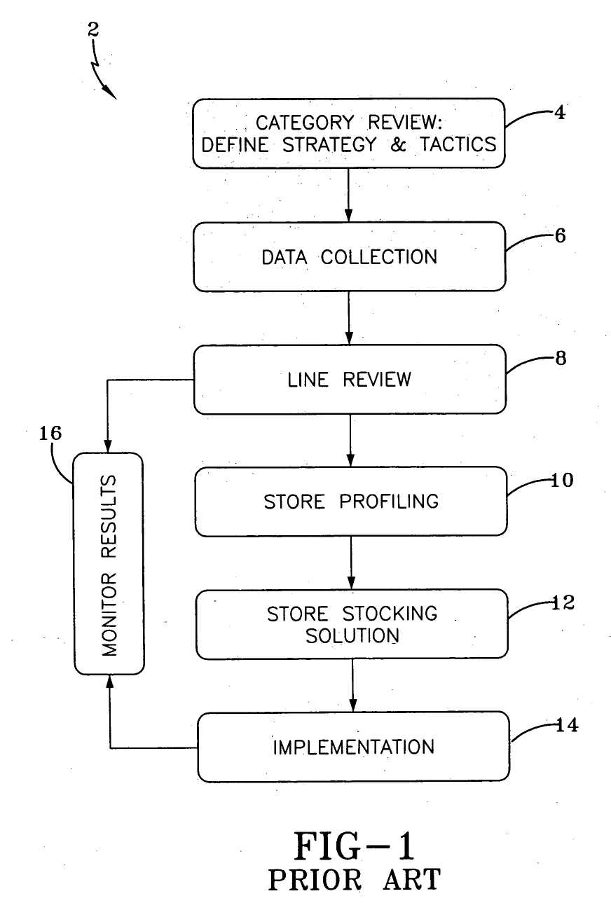

Referring initially to FIG. 1, a prior art method 2 for product category management is shown that is dependent on access to sales per store history at the retail level. As explained, access to such sensitive information is often problematic and there is a natural reluctance to share detailed sales information by market and product line. While the subject methodologies, both prior art and the invention, find general application in a wide range of product categories, for the purpose of a detailed description, the tire product category shall be used. Tire lines are particularly suitable for exemplary use since tires are manufactured in various sizes to accommodate vehicle variation. In addition, competing lines of tires are commonly sold by the same retail outlet, making a system that is not dependent on access to sensitive store sales information particularly valuable. Finally, tire product lines are particularly in need of category management given the high cost of inventorying tires at both the retail and the manufacturing level. Accordingly, specific application of the inventive methodology will be in tire category management but management of other product lines will also find the use of the inventive method beneficial.

The prior art approach 2 begins by conducting a category review 4 to define strategy and tactics. The category review 4 defines segments to serve, uncover missed opportunities and areas to reinforce. Brand strategy may further be established and metrics may be proposed.

After the category review is complete, data is collected 6 using sales history by store. Information on sales is collected such as SKU's, units, and revenue. A line review 8 is then conducted in which a comparison of existing and proposed tire lines' profitability, rotation and return on investment. Tire lines may be added, maintained, or reduced based on respective line performance. A profiling of stores 10 is also conducted, in which trade areas are calculated and a determination is made as to vehicle population and tire size potentials in the trade areas. Such information regarding vehicle population is readily available from public sources such as vehicle registration databases. The vehicle population and age of that population is further used as explained below to estimate market potential for tires.

A store stocking solution 12 is then configured, providing stocking recommendations for each store using metrics, capacity, frequency of restocking and delivery, potential market and sales history. The recommendations are reviewed and modified as necessary. The stocking recommendation is implemented 14. As a result, SKU's may be discontinued, stocking levels at individual stores may be adjusted, and/or new tire SKU's may be added to the product offering of a store. The entire process 2 is monitored and the results fed back 16 into further line review 8 on a continuous basis.

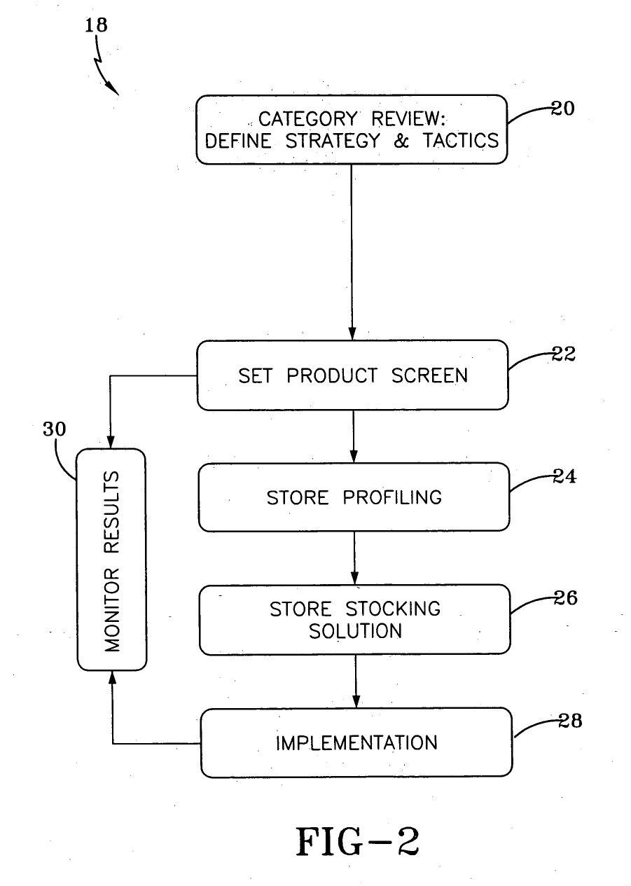

The information and data required in step 6 are, as discussed previously, often not available from retail operators reluctant to share sensitive sales history by product line, SKU, units, and revenue. Consequently, conventional category management, without sales history, is ill equipped to provide a reliable stocking recommendation. In order to overcome the reliance on sales history in traditional category management, the subject invention method 18 illustrated in FIG. 2 does not use sales history by store in devising an effective category management stocking recommendation. The method 18 uses a preliminary category review 20 and then proceeds to set a product screen 22, positioning existing and proposed tire lines. Tire information such as SKU, brand, line, size, performance characteristics, application may be placed into a table for evaluation. As discussed above, store profiling 24 is conducted in which trade areas are calculated and vehicle population and tire size potential is determined. Store stocking solutions are generated 26, preferably although not necessarily, by an interactive process using the internet web. The product screen is optimized in the process. The store stocking solutions are implemented 28 and a particular store's stocking plan is adjusted according to results and the store's own experience. Feedback 30 is provided by which to adjust the product screen 22.

The product screen 22 in the subject method is facilitated by a product screen optimizing tool that is preferably, but not necessarily, web-based. The interactive tool helps advise new or existing dealers or retailers on what tire lines to carry; what sizes and what quantities to stock based on a dealer's store location and trade area. If web based as recommended, the tool is accessible from anywhere. The output from the tool for each dealer's trade area may be constructed to provide: stocking recommendation; top tire sizes; top original equipment fitments for a particular trade area; top tire sizes. Demographics may also be outputted for a dealer's trade area, providing such information as population, average income, income ranges, etc.

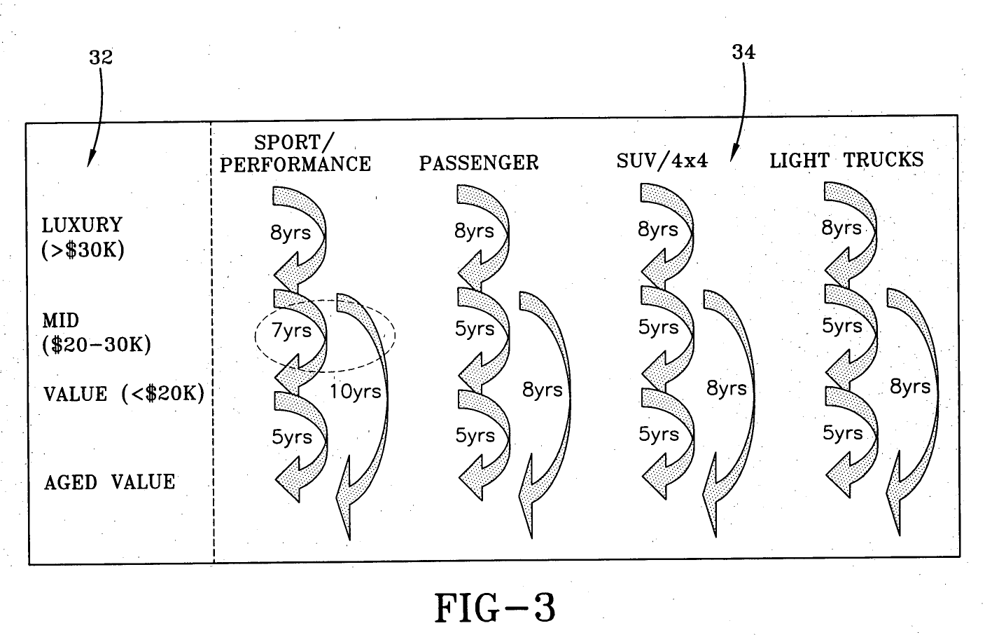

The product screen optimizing tool operates in a series of steps. The customer and store address is first identified; a trade area is established based on an area radius. Tire storage capacity of the store and any applicable store-determined allocation limitations are identified. Next a vehicle distribution grid is analyzed, such as the grid shown in FIG. 3 and a decision is made as to which segment(s) to focus on. The dealer chooses brands that will be used for a stocking recommendation and tire lines within each brand that will be used for the recommendation are identified. A stocking recommendation report is generated and any adjustments from recommended quantities; or decisions to add/replace/delete tire lines are made. The decisions made in the above process may be imputed into storage for future reference and/or modification.

FIG. 3 shows a grid in which the current market value for vehicles are along the left column 32 and vehicles by intended use along the top 34. The tire market segmentation is shown in the 16 box grid. As a vehicle ages, it is known that the vehicle becomes more likely to have its tires replaced. It is also known that from vehicle to vehicle intended use category, the aging rules vary and an adjustment is necessary according to aging rules to ascertain the likelihood a vehicle will be replacing its tires. The aging rules are indicated in the grid by arrows and vehicle age. For example, a vehicle with a greater than $30,000 current market value will have an aged value of a mid range ($20-30,000) vehicle. It is the aged value of the vehicle that is used to determine whether the vehicle will be a candidate for tire replacement in the product screen analysis.

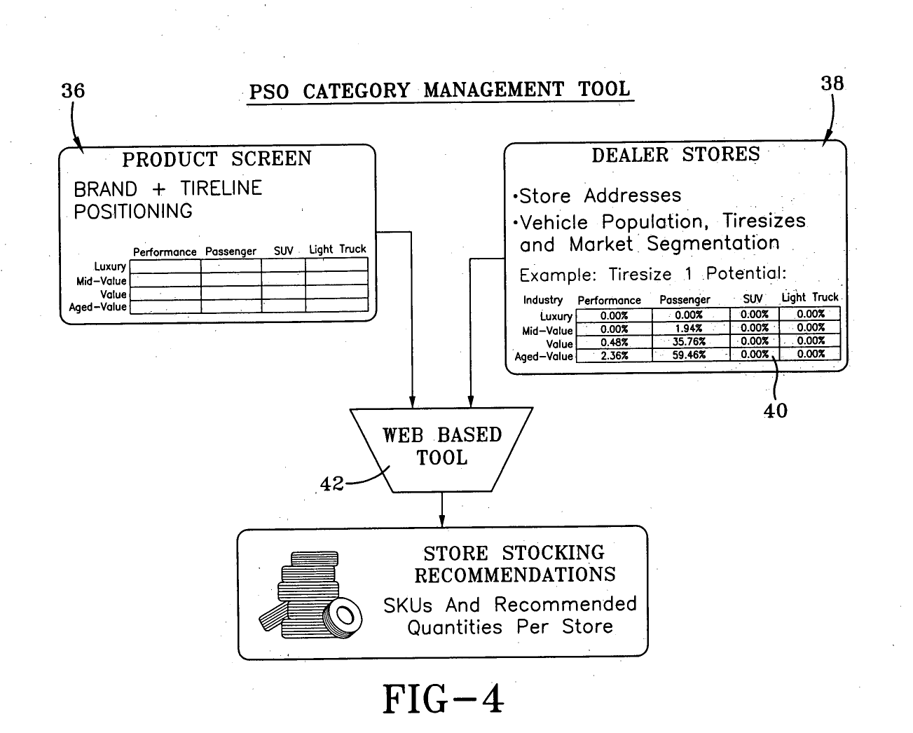

FIG. 4 shows a summary of the subject invention. A product screen 36 is developed that incorporates brand offerings into tire line positioning in a 16 block grid. The left column identifies vehicle by value type and along the horizontal top row are the four commonly used intended uses: performance, passenger; SUV, and light trucks. The grid is filled in to identify how many of each vehicle type/intended use are in a given market area. The dealer stores each provide an input 38, identifying the store by address. Each store will have a market area in which the vehicle population, tire sized, and market segmentation is determined. An example is given in the percentages in each block of grid 40 of FIG. 4. As shown by example, 35.76% of the vehicle population will be passenger cars in the value category. 1.94% of passenger vehicles in the market area will be in the mid-value range. Based on a combined consideration of the Product screen 36 and the Dealer Store profile 38, using the web based tool 42, a store stocking recommendation is constructed. SKU's and recommended quantities per store and the tire brand/SKU that will satisfy the recommendation are identified.

The decision on stocking is, therefore, made without any reference to historical sales data of a given store. Rather, the decision is made on the basis of combining a product screen with a store profile in order to create a store stocking recommendation. To assist in the accuracy of the vehicle percentages in each dealer store profile 38, an adjusted age of each vehicle may be determined and it is the adjusted age, rather than the actual age of the vehicle, that determines which block of the 16 in grid 38 that vehicle will fall.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of product category management comprising:
defining segments to serve;
set a product screen of product characteristics for existing product lines and proposed product lines;
calculate at least one trade area;
determine product population and product demand potential within the trade area;
derive a store stocking solution based on product demand potential; implement the store stocking solution.

2. The method according to claim 1 further comprising monitoring results of the store stocking solution to determine the necessity for an adjustment to the product screen.

3. The method according to claim 1 wherein the product information used in the product screen is taken from at least one of the group: SKU number, brand, line, size.

4. The method according to claim 1, wherein the product comprises a line of tires, the product information used in the product screen is taken from at least one category within the group: SKU number, brand, line, and size.

5. The method according to claim 4, wherein the tire population is derived from a vehicle population within the trade area.

6. The method according to claim 5 wherein the product demand potential is at least partially based on the age of the vehicle population within the trade area.

7. A method of tire category management comprising:
conducting a tire category review;
setting a tire screen positioning existing and proposed tire lines;
creating a tire line table based on a plurality of tire information categories;
profiling at least one store within at least one trade area;
determining tire population and tire potential within the one trade area based tire characteristic;
deriving a store stocking recommendation based on the tire population and tire potential.

8. The method according to claim 7, wherein further comprising monitoring results of the store stocking solution to determine the necessity for an adjustment to the tire screen.

9. The method according to claim 7 wherein the tire information categories comprise SKU number, brand, line, tire size.

10. The method according to claim 7 wherein the tire population is derived from a vehicle population within the trade area.

11. The method according to claim 10 wherein the tire demand potential is at least partially based on the age of the vehicle population within the trade area.

12. The method according to claim 10, wherein the tire population is age weighted within the trade area based upon vehicle population age.
